(19) United States
(12) Patent Application Publication
(10) Pub. No.: US 2020/0201562 A1
(43) Pub. Date: Jun. 25, 2020

(54) MEMORY DEVICE, MEMORY SYSTEM AND METHOD OF READING FROM MEMORY DEVICE

(71) Applicant: NANYA TECHNOLOGY CORPORATION, NEW TAIPEI CITY (TW)

(72) Inventors: CHIH-WEI SHEN, YUNLIN COUNTY (TW); TING-SHUO HSU, NEW TAIPEI CITY (TW)

(21) Appl. No.: 16/369,719

(22) Filed: Mar. 29, 2019

Related U.S. Application Data
(60) Provisional application No. 62/782,676, filed on Dec. 20, 2018.

(51) Int. Cl. G06F 3/06

(52) U.S. Cl. CPC G06F 3/0658; G06F 3/0683; G06F 3/0604; G06F 3/0659

(57) ABSTRACT

The present disclosure provides a memory device. The memory device includes a memory manager, a high-ranking memory and a low-ranking memory, wherein the high-ranking memory and the low-ranking memory are electrically connected to the memory manager. The memory manager replaces information provided by the high-ranking memory with information provided by the low-ranking memory when a swap request is received.

### PRIORITY CLAIM AND CROSS-REFERENCE

This application claims the priority benefit of U.S. provisional application Ser. No. 62/782,676, filed on Dec. 20, 2018. The entirety of the above-mentioned patent application is hereby incorporated by reference herein and made a part of this specification.

### TECHNICAL FIELD

The present disclosure relates to a memory device, a memory system and a method of reading from the memory device and, more particularly, to a semiconductor memory device, a semiconductor memory system, and a method of reading from the semiconductor memory device.

### DISCUSSION OF THE BACKGROUND

In general, semiconductor memory devices, such as dynamic random access memories (DRAMs), have a high integration density and operate at high speed, each memory cell typically having one access transistor and one storage capacitor.

In addition, a computer system may include a plurality of DRAMs in a memory module for high performance and large volume, wherein the DRAMs may be packaged in various ways according to intended uses thereof.

This Discussion of the Background section is provided for background information only. The statements in this Discussion of the Background are not an admission that the subject matter disclosed in this Discussion of the Background section constitute prior art to the present disclosure, and no part of this Discussion of the Background section may be used as an admission that any part of this application, including this Discussion of the Background section, constitutes prior art to the present disclosure.

### SUMMARY

One aspect of the present disclosure provides a memory device. The memory device includes a high-ranking memory, a low-ranking memory and a memory manager. The memory manager is electrically coupled to the high-ranking memory and the low-ranking memory and is configured to replace information provided by the high-ranking memory with information provided by the low-ranking memory when a swap request is received.

In some embodiments, the memory manager comprises a swap control unit configured to replace addresses of the high-ranking memory with addresses of the low-ranking memory, and the memory manager accesses the information stored in the low-ranking memory by referring to the swap request.

In some embodiments, the memory manager disables the high-ranking memory when the swap request is received.

In some embodiments, the memory manager accesses the information stored in the high-ranking memory and the low-ranking memory when a multi-memory output request is received.

In some embodiments, the memory manager accesses the information stored by the high-ranking memory when a single-memory output request is received.

In some embodiments, the memory manager disables the low-ranking memory when the single-memory output request is received.

Another aspect of the present disclosure provides a memory system. The memory system includes a memory controller and a memory device coupled to the memory controller. The memory device includes a high-ranking memory, a low-ranking memory and a memory manager electrically coupled to the high-ranking memory and the low-ranking memory. The memory manager replaces information provided by the high-ranking memory with information provided by the low-ranking memory when a swap request provided by the memory controller is received.

In some embodiments, the memory manager comprises a swap control unit configured to replace addresses of the high-ranking memory with addresses of the low-ranking memory by referring to the swap request, and the memory manager provides the information stored in the low-ranking memory to the memory controller.

In some embodiments, when a request provided from the memory controller to the memory device is a multi-memory output request, the memory manager provides information stored in the high-ranking memory and the low-ranking memory to the memory controller.

In some embodiments, when a command provided from the memory controller to the memory device is a single-memory output request, the memory manager provides the information stored in the high-ranking memory to the memory controller.

Another aspect of the present disclosure provides a method of reading information stored in a memory device. The method includes steps of determining whether a swap request is received or not; and replacing first physical addresses of a high-ranking memory with second physical addresses of a low-ranking memory of the memory device as an operation to read information stored in the low-ranking memory when the swap request is received.

In some embodiments, the method further includes a step of accessing information stored in the low-ranking memory using the second physical address.

In some embodiments, the step further includes a step of disabling the high-ranking memory when the swap request is received.

In some embodiments, the swapping is performed using a memory manager internal to the memory device.

In some embodiments, the method further includes steps of determining whether a multi-memory output request is received or not; and accessing information stored in the high-ranking memory using the first physical addresses and accessing information stored in the low-ranking memory using the second physical addresses when the multi-memory output request is received.

In some embodiments, the method further includes a step of accessing information stored in the high-ranking memory using the first physical addresses when the multi-memory output request is not received.

In some embodiments, the high-ranking memory and the low-ranking memory are volatile memories.

With the above-mentioned configurations of the memory device, the swap control unit is configured to replace addresses of a high-ranking memory with addresses of a low-ranking memory, thus the information stored in the low-ranking memory can be provided to the memory controller during the single-memory output operation, which can support user to build the memory device easily.

The foregoing has outlined rather broadly the features and technical advantages of the present disclosure in order that the detailed description of the disclosure that follows may be better understood. Additional features and technical advantages of the disclosure are described hereinafter, and form the subject of the claims of the disclosure. It should be appreciated by those skilled in the art that the concepts and specific embodiments disclosed may be utilized as a basis for modifying or designing other structures, or processes, for carrying out the purposes of the present disclosure. It should also be realized by those skilled in the art that such equivalent constructions do not depart from the spirit or scope of the disclosure as set forth in the appended claims.

### BRIEF DESCRIPTION OF THE DRAWINGS

A more complete understanding of the present disclosure may be derived by referring to the detailed description and claims. The disclosure should also be understood to be coupled to the figures' reference numbers. which refer to similar elements throughout the description.

FIG. 1 is a block diagram of a memory system in accordance with some embodiments of the present disclosure.

FIG. 2 is a block diagram of a memory device in accordance with some embodiments of the present disclosure.

FIG. 3 is a flow diagram illustrating a method of reading information from a memory device, in accordance with an embodiment of the present disclosure.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, components, regions, layers or sections, these elements, components, regions, layers or sections are not limited by these terms. Rather, these terms are merely used to distinguish one element, component, region, layer or section from another element, component, region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limited to the present inventive concept. As used herein, the singular forms “a,” “an” and “the” are intended to include the plural forms as well, unless the context clearly indicates otherwise. It shall be further understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

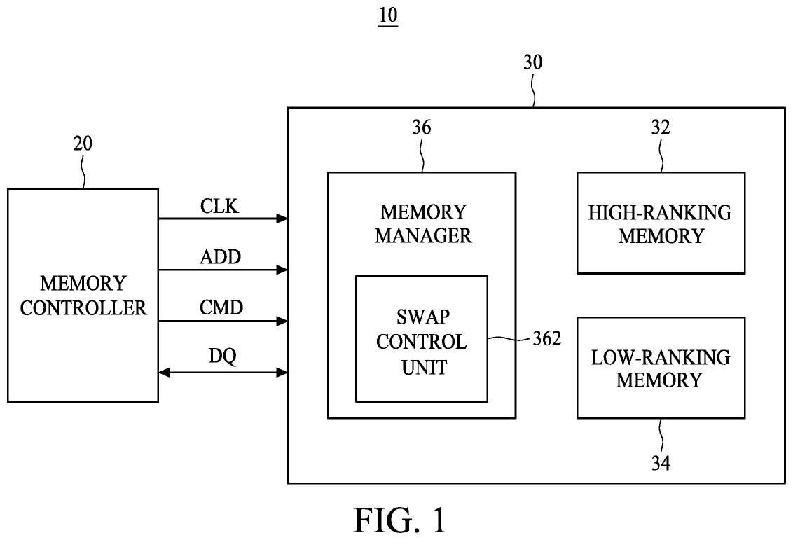

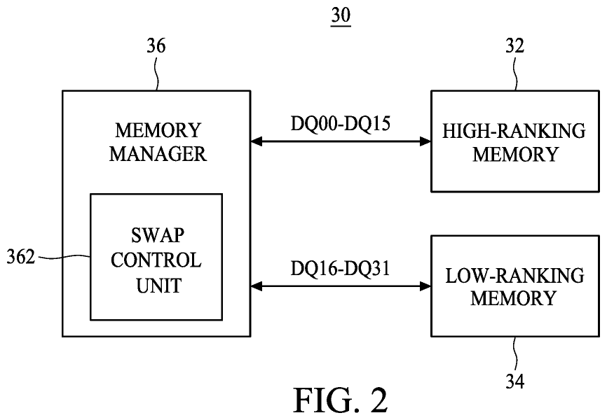

FIG. 1 is a block diagram of a memory system 10 in accordance with some embodiments of the present disclosure, and FIG. 2 is a memory device 30 in accordance with some embodiments of the present disclosure. Referring to FIGS. 1 and 2, the memory system 10 includes a memory controller 20 and a memory device 30 coupled to the memory controller 20. In some embodiments, the memory controller 20 may be a discrete component or device and may be external to the memory device 30. The memory controller 20 may include digital logic to execute software instructions and may also be referred to as a central processing unit (CPU). In some embodiments, the memory controller 20 provides various signals, e.g., a command CMD, an address ADD, and a clock CLK for controlling the memory device 30, and the memory controller 20 can communicate with the memory device 30 to receive information DQ from the memory device 30 or provide information DQ to the memory device 30, wherein the term “information” may be used to refer to data, instructions, or code.

In some embodiments, the memory device 30 includes a high-ranking memory 32 and a low-ranking memory 34 capable of storing one or more bits of information. In some embodiments, the high-ranking memory 32 and the low-ranking memory 34 are discrete memories. In some embodiments, the high-ranking memory 32 and the low-ranking memory 34 are volatile memories, such as dynamic random access memories. In some embodiments, the high-ranking memory 32 is capable of storing 16 bits of information, labeled as information DQ00-DQ15, and may be assigned or mapped to first physical addresses; the low-ranking memory 34 is capable of storing 16 bits of information, labeled as information DQ16-DQ31, and may be assigned or mapped to second physical addresses.

In some embodiments, the memory device 30 further includes a memory manager 36 electrically coupled to the high-ranking memory 32 and the low-ranking memory 34 and configured to control the high-ranking memory 32 and the low-ranking memory 34 to individually or collectively provide information DQ00-DQ15, DQ16-DQ31 in response to the commands CMD from the memory controller 20. In some embodiments, the memory controller 20 may be able to access information using the first physical addresses and the second physical addresses. In some embodiments, the memory manager 36 may include circuitry such as, for example, digital logic, and may optionally execute code that may be used to perform functions for a reading operation. In addition, the memory manager 36 may also be used to perform various control activities for the memory device 30. For example, in addition to the reading operation, the memory manager 36 may also be used to perform writing, erasing, and updating operations in the memory device 30 in response to write, erase, or update commands from the memory controller 20. In some embodiments, the memory manager 36 may also be referred to as a control circuit and in various embodiments may be an application specific integrated circuit (ASIC) or a processor such as, for example, a microprocessor, a co-processor, or a microcontroller.

In some embodiments, in the memory device 30 including the high-ranking memory 32 and the low-ranking memory 34, a priority is pre-assigned to the high-ranking memory 32. As a result, when a single-memory output operation is enabled, the high-ranking memory 32 having the priority is enabled and provides the information DQ00-DQ15 to the memory controller 20, and the low-ranking memory 34 without the priority is disabled and the information DQ16-DQ31 provided by the low-ranking memory 34 is interrupted. However, this presents inconvenience and hassle to users.

In order to overcome the problem mentioned above, the memory manager 36 of the present disclosure may include a swap control unit 362 coupled to the high-ranking memory 32 and the low-ranking memory 34 and configured to replace information provided by the high-ranking memory 32 with information provided by the low-ranking memory 34 by referring to a swap request from the memory controller 20. Specifically, when the command CMD outputted from the memory controller 20 is the swap request, the swap control unit 362 of the memory manager 36 runs in response to the swap request to replace the first physical addresses of the high-ranking memory 32 with the second physical addresses of the low-ranking memory 34, and the memory manager 20 may access the information DQ16-DQ31 stored in the low-ranking memory 34 using the second physical addresses to provide the information DQ16-DQ31 to the memory controller 20. In some embodiments, the memory manager 36 may not access the information DQ00-DQ15 stored in the high-ranking memory 32 when the swap request is received. In some embodiments, the memory manager 36 may disable the high-ranking memory 32 when the swap request is received.

In some embodiments, when the command CMD outputted from the memory controller 20 is a multi-memory output request, the memory manager 36 not only accesses information DQ00-DQ15 stored in the high-ranking memory 32 using the first physical addresses but also accesses the information DQ16-DQ31 stored in the low-ranking memory 34 using the second physical addresses so as to provide the information DQ00-DQ31 to the memory controller 20.

In some embodiments, when the command CMD outputted from the memory controller 20 is a single-memory output request or does not include the swap request or the multi-memory output request, the memory manager 36 accesses the information DQ00-DQ15 stored in the high-ranking memory 32 using the first physical addresses so as to provide the information DQ00-DQ15 to the memory controller 20. In some embodiments, the memory manager 36 may not access the information DQ16-DQ31 stored in the low-ranking memory 34 when the single-memory output request is received. In some embodiments, the memory manager 36 may disable the low-ranking memory 34 when the single-memory output request is received.

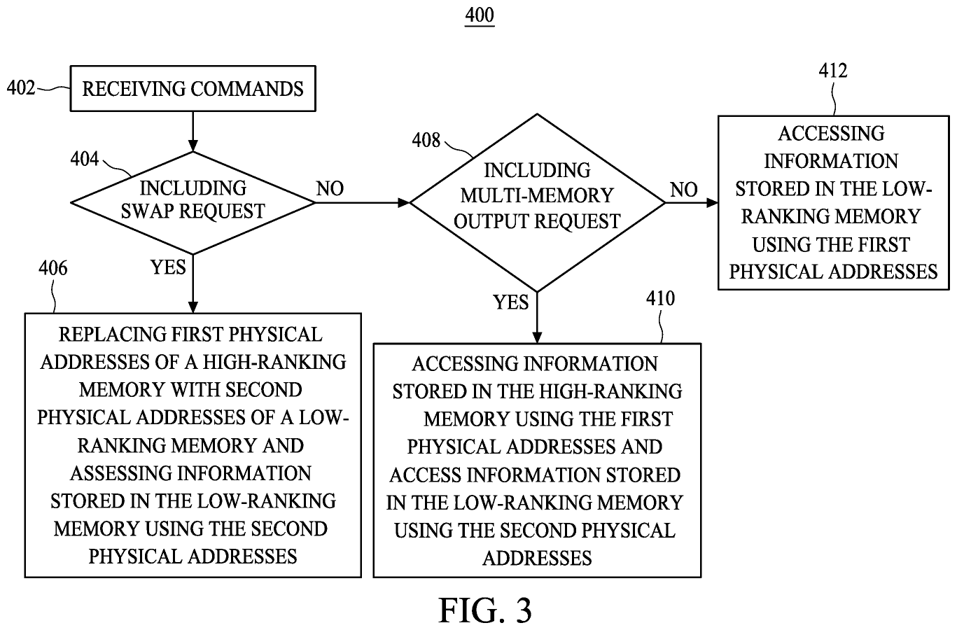

FIG. 3 is a flow diagram illustrating a method 400 to perform a reading operation in a memory device in accordance with an embodiment of the present disclosure. This method will be described with reference to the memory device 30 in FIG. 1. Although the individual steps or acts of the method 400 are illustrated and described below as separate acts, one or more of the individual acts may be performed concurrently and the scope of the present disclosure is not limited to performing these acts in the order illustrated.

As will be discussed below, in some embodiments, steps 402, 404, 406, 408, 410, and 412 of method 400 may be performed by code, for example, by memory management software that is executed using the memory manager 36 shown in FIGS. 1 and 2. In some embodiments, the method 400 may be used to read information stored in the high-ranking memory 32 and the low-ranking memory 34. In some embodiments, information read by software that is executed using the memory manager 36 may be performed in steps 402, 404, 406, 408, 410 and 412 of the method 400.

In some embodiments, method 400 includes the step 402, in which commands provided by an external controller are received; the step 404, in which it is determined whether the received commands include a swap request or not; the step 406, in which first physical addresses of the high-ranking memory 32 are replaced with second physical addresses of the low-ranking memory 34 of the memory device 30, and information stored in the low-ranking memory 34 is accessed using the second physical addresses when the commands include the swap request; the step 408, in which it is determined whether the received commands include a multi-memory output request or not when the command does not include the swap request; the step 410, in which the information stored in the high-ranking memory is accessed using the first physical addresses and the information stored in the low-ranking memory is accessed using the second physical addresses when the commands include the multi-memory output request; the step 412, in which the information stored in the low-ranking memory is accessed using the first physical addresses when the commands do not include the swap request or the multi-memory output request.

In some embodiments, the high-ranking memory 32 is disabled when the command is the swap request, and the information DQ00-DQ15 provided by the high-ranking memory 32 is interrupted. In some embodiments, the low-ranking memory 34 is disabled when the commands do not include the swap request or the multi-memory output request, and the information DQ16-DQ31 provided by the low-ranking memory 34 is interrupted.

In conclusion, with the configurations of the memory device 30, the swap control unit 362 of the present invention can replace the first physical addresses of the high-ranking memory 32 with the second physical addresses of the low-ranking memory 34, thus the information stored in the low-ranking memory 34 can be provided to the memory controller 30 during the single-memory output operation, which can support user to build the memory device 30 easily.

One aspect of the present disclosure provides a memory device. The memory device includes a high-ranking memory, a low-ranking memory and a memory manager. The memory manager is electrically coupled to the high-ranking memory and the low-ranking memory and is configured to replace information provided by the high-ranking memory with information provided by the low-ranking memory when a swap request is received.

One aspect of the present disclosure provides a memory system. The memory system includes a memory controller and a memory device coupled to the memory controller. The memory device includes a high-ranking memory, a low-ranking memory, and a memory manager. The memory manager is electrically coupled to the high-ranking memory and the low-ranking memory and replaces information provided by the high-ranking memory with information provided by the low-ranking memory when a swap request provided by the memory controller is received.

One aspect of the present disclosure provides a method of reading information stored in a memory device. The method includes steps of determining whether a swap request is received or not; and replacing a first physical addresses of a high-ranking memory with a second physical addresses of a low-ranking memory of the memory device as an operation to read information stored in the low-ranking memory when the swap request is received.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods and steps.

What is claimed is:

1. A memory device, comprising:
a high-ranking memory:
a low-ranking memory; and
a memory manager electrically coupled to the high-ranking memory and the low-ranking memory and configured to replace information provided by the high-ranking memory with information provided by the low-ranking memory when a swap request is received.

2. The memory device of claim 1, wherein the memory manager comprises a swap control unit configured to replace addresses of the high-ranking memory with addresses of the low-ranking memory, and the memory manager accesses the information stored in the low-ranking memory by referring to the swap request.

3. The memory device of claim 1, wherein the memory manager disables the high-ranking memory when the swap request is received.

4. The memory device of claim 1, wherein the memory manager accesses the information stored in the high-ranking memory and the low-ranking memory when a multi-memory output request is received.

5. The memory device of claim 1, wherein the memory manager accesses the information stored by the high-ranking memory when a single-memory output request is received.

6. The memory device of claim 5, wherein the memory manager disables the low-ranking memory when the single-memory output request is received.

7. A memory system, comprising:
a memory controller; and
a memory device, coupled to the memory controller, the memory device comprising:
a high-ranking memory;
a low-ranking memory; and
a memory manager electrically coupled to the high-ranking memory and the low-ranking memory, wherein the memory manager replaces information provided by the high-ranking memory with information provided by the low-ranking memory when a swap request provided by the memory controller is received.

8. The memory system of claim 7, wherein the memory manager comprises a swap control unit configured to replace addresses of the high-ranking memory with addresses of the low-ranking memory by referring to the swap request, and the memory manager provides the information stored in the low-ranking memory to the memory controller.

9. The memory system of claim 8, wherein when a command provided from the memory controller to the memory device is a multi-memory output request, the memory manager provides information stored in the high-ranking memory and the low-ranking memory to the memory controller.

10. The memory system of claim 9, wherein when a command provided from the memory controller to the memory device is a single-memory output request, the memory manager provides the information stored in the high-ranking memory to the memory controller.

11. A method of reading information stored in a memory device, the method comprising:
determining whether a swap request is received or not; and
replacing first physical addresses of a high-ranking memory with second physical addresses of a low-ranking memory of the memory device as an operation to read information stored in the low-ranking memory when the swap request is received.

12. The method of claim 12, further comprising accessing information stored in the low-ranking memory using the second physical address.

13. The method of claim 12, further comprising disabling the high-ranking memory when the swap request is received, so that information provided by the high-ranking memory is interrupted.

14. The method of claim 12, wherein the swapping is performed using a memory manager internal to the memory device.

15. The method of claim 13, further comprising:
determining whether a multi-memory output request is received or not; and
accessing information stored in the high-ranking memory using the first physical addresses and accessing information stored in the low-ranking memory using the second physical addresses when the multi-memory output request is received.

16. The method of claim 12, further comprising accessing information stored in the high-ranking memory using the first physical addresses when the swap request and the multi-memory output request are not received.

17. The method of claim 12, wherein the high-ranking memory and the low-ranking memory are volatile memories.
